(19) United States
(12) Patent Application Publication
(10) Pub. No.: US 2008/0286713 A1
(43) Pub. Date: Nov. 20, 2008

(54) TOOTHBRUSH WITH ILLUMINATION SYSTEM

(76) Inventor: Puneet Nanda, Cerritos, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/122,593

(22) Filed: May 16, 2008

Related U.S. Application Data
(60) Provisional application No. 60/938,430, filed on May 16, 2007.

(51) Int. Cl. A61C 3/00; A61C 5/00; A46B 9/04; A46D 1/00; A46B 15/00

(52) U.S. Cl. 433/29; 433/215; 15/167.1; 15/207.2; 15/105

(57) ABSTRACT

Disclosed herein are toothbrushes. The toothbrushes have an illumination system. In some arrangements, the toothbrush can have bristles that are illuminated by the illumination system. The illumination system can be positioned with a toothbrush head having bristles with metal particles disposed in or on the bristles.

### CROSS-REFERENCE TO RELATED APPLICATIONS

This application claims the priority benefit under 35 U.S.C. § 119(e) of Provisional Application 60/938,430, filed May 16, 2007, the entire contents of which are hereby incorporated by reference herein.

### BACKGROUND OF THE INVENTION

1. Field of the Invention

The present invention relates to dental hygiene products, and more particularly, to toothbrushes.

2. Description of the Related Art

To ensure proper oral care, dentists recommend that people brush their teeth more than once a day for at least two to three minutes each time. Despite this recommendation, the average adult person does not brush his or her teeth for two to three minutes. This problem is worse with children, who generally tend to have shorter attention spans, and often view brushing their teeth as a chore. Accordingly, there is a general need for a device that encourages people, especially children, to brush their teeth more often and for longer periods of time.

Though toothbrushes are sanitary aids, they are repeatedly disposed in the mouth while in use, and frequently put into storage while still wet. Accordingly, toothbrushes, particularly the heads and bristles can become a location susceptible of infestation by bacteria or other undesirable microbes. Thus, there is a need for a toothbrush that inhibits the proliferation of bacteria on the toothbrush.

Additionally, toothbrushes can be used in combination with a dentifrice to aid whitening of teeth. When thusly employed, the effect of the dentifrice can be enhanced by providing light to the dentifrice. Typically, the dentifrice contains metallic ions which can serve as a catalyst to enhance the whitening reaction. However, the dentifrice can be simplified, particularly if the metallic ions could be removed from it without reducing its whitening effectiveness.

### SUMMARY OF THE INVENTION

A toothbrush comprising a head having a plurality of bristles configured to clean teeth and at least one illumination element that outputs light, the illumination element positioned within the head, and at least one of the plurality of bristles having a plurality of metal particles, and a body extending from the head, the body defining a handle for gripping by a user, a power source for delivering energy to the at least one illumination element.

### BRIEF DESCRIPTION OF THE DRAWINGS

These and other aspects of the inventions will be readily apparent from the detailed description below and the appended drawings, which are meant to illustrate and not to limit the invention. The drawings contain the following figures.

FIG. 1A is a front elevational view of a toothbrush having an illumination system.

FIG. 1B is a side elevational view of the toothbrush of FIG. 1A with a closure in an open position.

FIG. 1C is a back elevational view of the toothbrush of FIG. 1A.

FIG. 1D is a cross-sectional view of the toothbrush of FIG. 1A.

FIG. 2A is a front elevational view of a toothbrush having an illumination system in accordance with another embodiment.

FIG. 2B is a side elevational view of the toothbrush of FIG. 2A with a closure in an open position.

FIG. 2C is a back elevational view of the toothbrush of FIG. 2A.

FIG. 3A is a perspective view of a toothbrush having an illumination system in accordance with another embodiment.

FIG. 3B is another perspective view of the toothbrush of FIG. 3A.

FIG. 4A is an enlarged perspective view of a head of the toothbrush of FIG. 3 when an illumination system is not activated.

FIG. 4B is an enlarged perspective view of the head of the toothbrush of FIG. 3A when the illumination system is activated.

FIG. 4C is another view of the head of the toothbrush of FIG. 3 when the illumination system is activated.

FIG. 5 is a perspective view of another embodiment of a toothbrush having an illumination system.

FIG. 6 is a detailed view of the head of the toothbrush illustrated in FIG. 5.

FIG. 7 is a detailed view of the bristles and head of the toothbrush illustrated in FIG. 6.

### DETAILED DESCRIPTION OF THE PREFERRED EMBODIMENTS

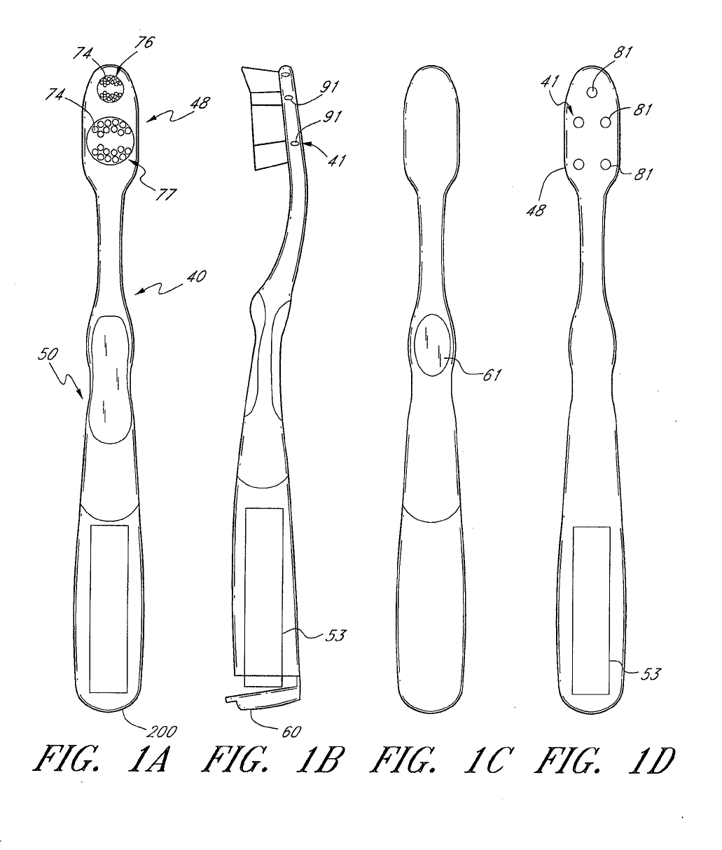

FIGS. 1A-D illustrate a toothbrush 40, that has an illumination system 41 that can be activated. In the illustrated embodiment, the illumination system 41 can include one or more illumination elements for outputting light. The toothbrush 40 comprises a toothbrush head 48, a body 50, and a closure 60 attached to the body 50. The closure 60 can be opened to expose an inner chamber that holds a power source 53 (e.g., a battery as illustrated). The toothbrush head 48 can be integrally mounted to the body 50, which extends downwardly and is attached to the closure 60.

With continued reference to FIGS. 1A-D, the head 48 can comprise a plurality of cleaning elements 74 configured to clean a person's teeth. The illustrated cleaning elements 74 are in the form of a plurality of bristles extending from the head 48. The bristles 74 can also be rotatably mounted to the mounting head 76. For example, the toothbrush 40 can be an automatic toothbrush (e.g., a motorized toothbrush) that moves (e.g., rotates or vibrates) the bristles 74 when turned ON. As illustrated, the body 50 can comprise a switch 61 (FIG. 1C) for turning the bristles 74 OFF/ON.

The switch 61 can be slidably mounted to the body 50. Such as switch 61 can be slid between an ON and OFF position. In alternative embodiments, the switch 61 can occupy an OFF position. The switch 61 can then be depressed to an ON position. Other types of switches can also be employed. The switch 61 also can operate both the bristles 74 and the illumination system. However, separate switches can be provided for the illumination system 41 and for the rotation of the bristles 74. Thus, the illumination system 41 and the bristles 74 can be operated independently.

The toothbrush 40 can comprise the power source 53, motor (e.g., an electric motor), a drive mechanism, etc. for rotating the bristles 74. The power source 53 can comprise one or more batteries, a power outlet, or other power supply that power an automatic toothbrush and/or the illumination system 41. The illustrated power source 53 is a single battery.

The illustrated head 48 has an upper set 76 and a lower set 77 of cleaning elements 74. The sets 76, 77 can be moved (e.g., rotated) while a person uses the toothbrush 40. Thus, the motorized head 48 can facilitate brushing due to the rotating cleaning elements 74. In alternative embodiments, the cleaning elements 74 can be fixedly attached to the head 48.

The illumination system 41 preferably comprises one or more illumination elements 91 that can be activated. In some embodiments, including the illustrated embodiment of FIG. 1D, the head 48 comprises a plurality of illumination elements 81 evenly or unevenly spaced along the head 48. The illumination elements 81 can be lighting elements that can be activated for a desired length of time. When the illumination elements 81 are activated, the bristles 74, which can be made of a translucent or semi-translucent material, can be illuminated to enhance the brushing experience.

To activate the illumination elements 81, the switch 61 can be moved to an ON position. Thus, the lighting elements 81 can be activated at any time. After a person brushes their teeth, the switch can be moved to an OFF position. Accordingly, the elements 81 can be energized for any length of time. The bristles 74 can be actuated and simultaneously illuminated, if desired.

In alternative embodiments, the illumination elements 81 of the toothbrush 40 can be activated when the toothbrush 40 is moved, such as during normal brushing. In some embodiments, the lighting elements 81 are activated when the bristles 74 are pressed against a surface. Pressure sensors can be disposed in the head 48 to determine when the bristles 74 engage a person's teeth. Alternatively, the lighting elements 81 can be activated when the toothbrush 40 undergoes a target temperature change or is exposed to a fluid, such as water.

In some embodiments, the lighting elements 81 can remain activated for a desired length of time, preferably corresponding to a desired brush period (e.g., 1 minute or 2 minutes). The lighting element can effectively function as a timer to ensure that a person utilizes the toothbrush 40 for a target period of time. Alternatively, the toothbrush can be configured so that the lighting elements are deactivated by one or more other methods, such as, for example, manually (e.g., actuating a switch, performing a particular task, etc.).

Each illumination element 81 can comprise one or more light sources (e.g., a diode) powered by a power source (e.g., a battery). The lighting element can pulse, remain continuously activated for the entire brushing period, or have a programmed sequence of activation. The lighting element can be activated to make brushing more enjoyable or fun, especially, for children.

The illumination elements can output light of various colors. If desired, the illumination element can output orange light, blue light, red light, green light, or any other color light. In some embodiments, a combination of different colors can be used and/or the different colors can be activated in a desired timing pattern. Of course, various colored materials can be employed with light sources to create light of a desired color. In some embodiments, the elements can be blue LEDs. Any other color and/or color combinations can also be used, including red, green and/or yellow.

The system 41 can have one or more optical windows that can transmit light rays. With respect to FIG. 1B, the head 48 has a plurality of optical windows 91 formed in the body of the head. Any number of optical windows 91 can be employed. The position of the optical windows 91 can be selected to achieve the desired illumination.

With reference again to FIGS. 1A to 1D, the toothbrush 40 can comprise any material suitable for forming a toothbrush. Transparent materials can be utilized so as to permit a person to view light outputted from the illumination elements. For example, the head 40 can comprise a somewhat clear hard plastic that can be formed, for example, by a molding process (e.g., an injection molding process, a compression molding process, etc.). Alternatively, the toothbrush 40 can comprise opaque materials. The body 50 can comprise polymers, metals, combinations thereof, or other materials having suitable mechanical properties for forming the body 50. The illustrated body 50 is a handle that can be conveniently gripped to hold the toothbrush 40.

The closure 60 is removably coupled to the body 50 and forms a bottom 200 of the toothbrush 40. As used herein, the term “closure” is a broad term and is used in its ordinary meaning and includes, without limitation, a cap, a cover, or other structure that can be attached to the body 50.

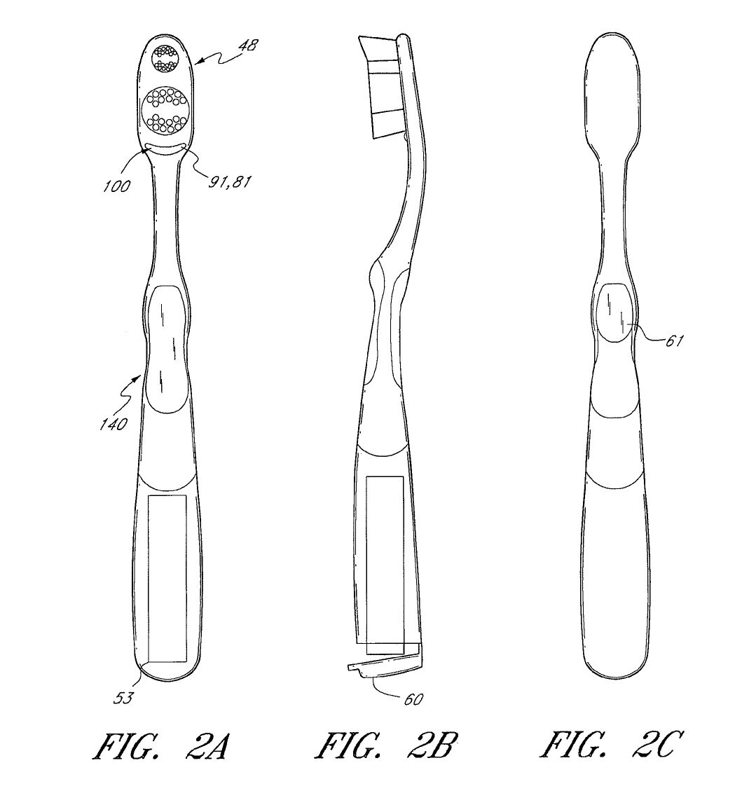

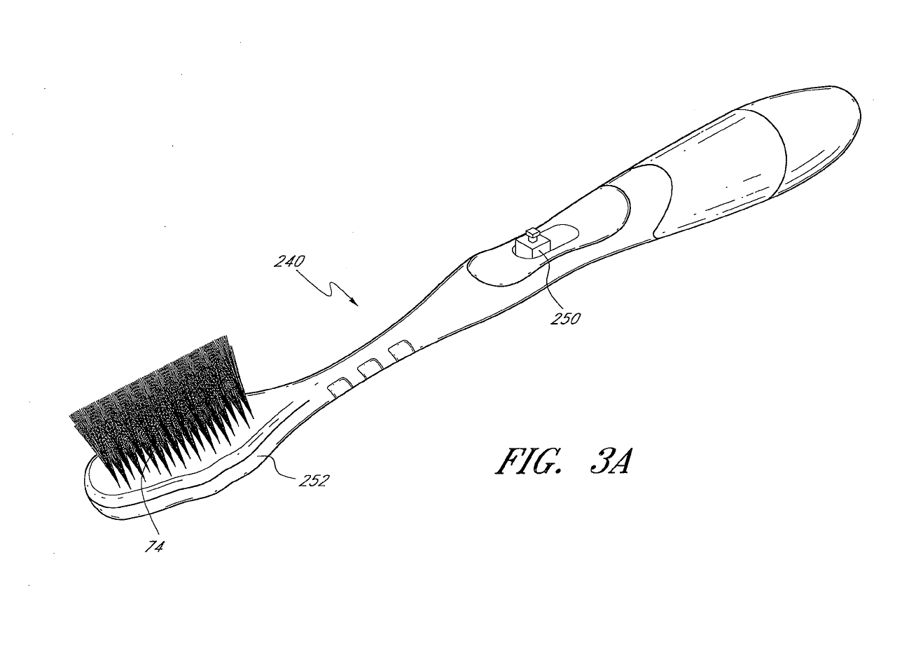

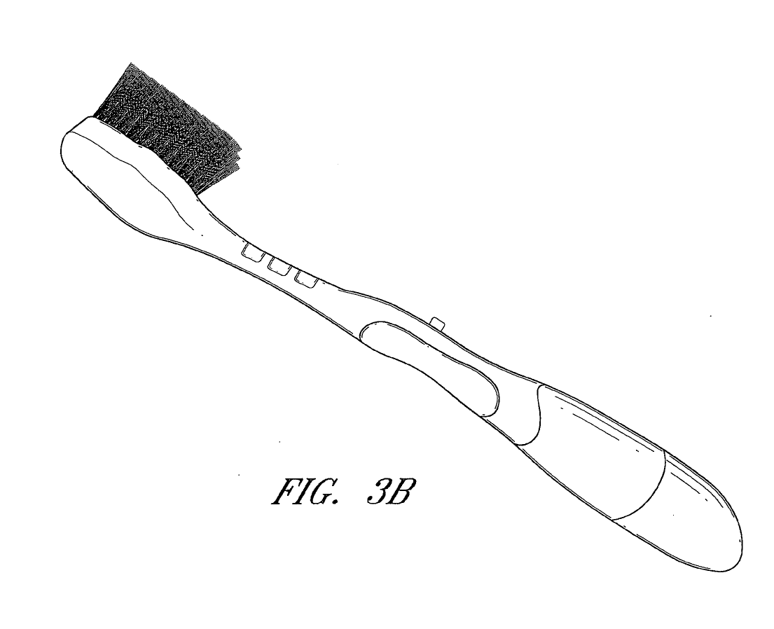

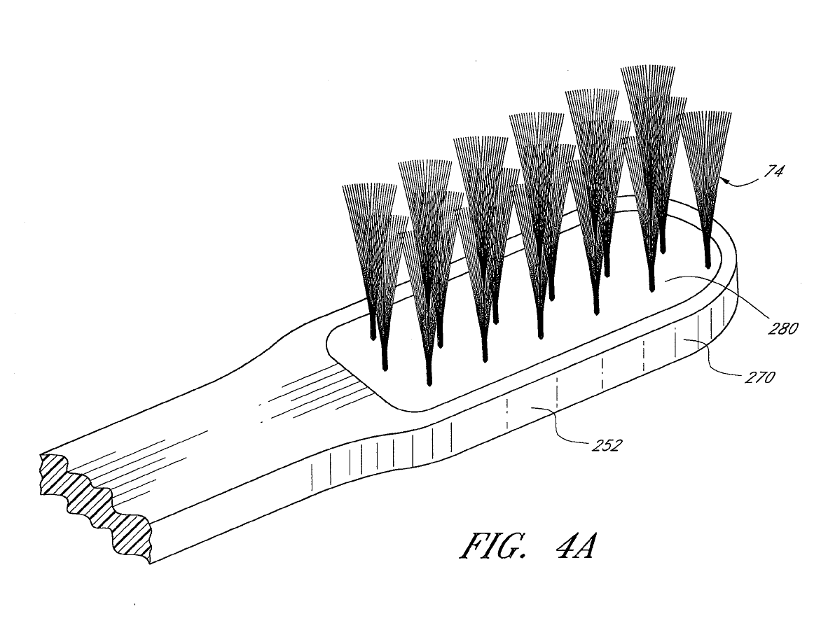

FIGS. 2A to 2C depict another embodiment of a toothbrush, which may be generally similar to the embodiment illustrated in FIGS. 1A to 1D, except as further detailed below. Where possible, similar elements in the multiple embodiments are identified with identical reference numerals to that of the depiction of the embodiment in FIGS. 1A-1D.

With continued reference to FIG. 2A, the brush 140 has an elongated illumination system 100 positioned on the front face of the head 48. The illustrated system 100 includes an optical window 91 and a lighting element 81. The arcuate illumination system 100 is positioned between the body 50 and the bristles, but the system 100 can be at other locations, if desired. In some embodiments, the illumination system can comprise one or more LEDs. For example, the illustrated illumination system 100 can be a single blue LED light.

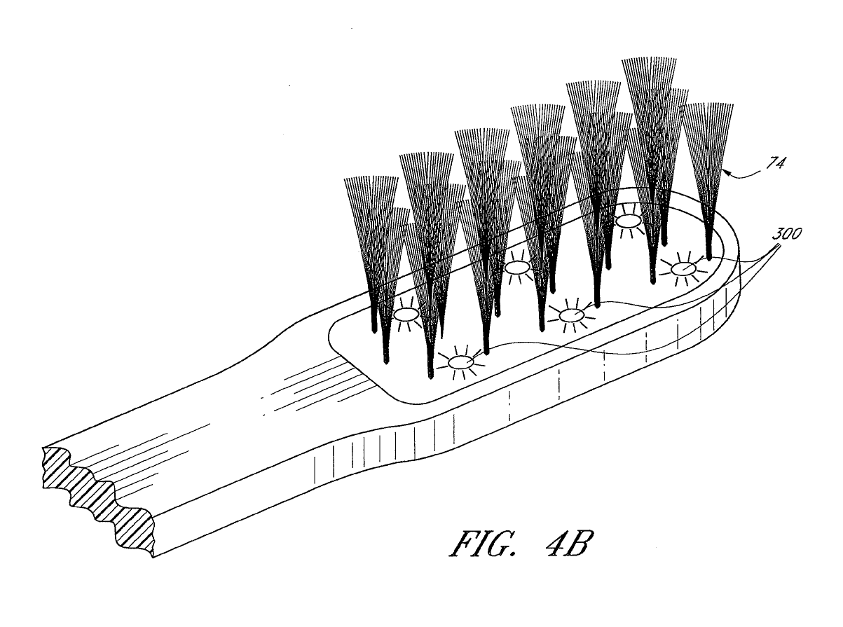

FIGS. 3A and 3B show perspective views of a toothbrush in accordance with another embodiment. The toothbrush 240 is generally similar to the toothbrushes described above, except as detailed below.

The toothbrush 240 has a switch 250 that can be actuated to turn OFF or ON an illumination system positioned within a head 252 of a toothbrush 240. In the illustrated embodiment, the bristles 74 are fixedly attached to the head 252.

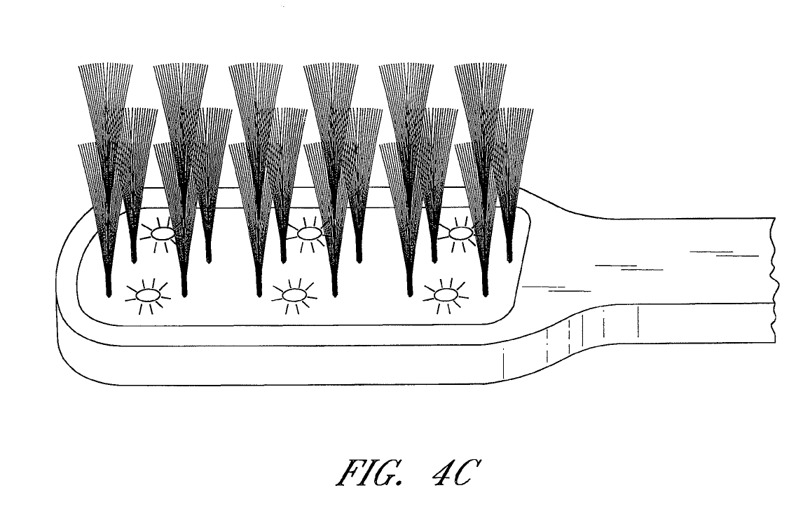

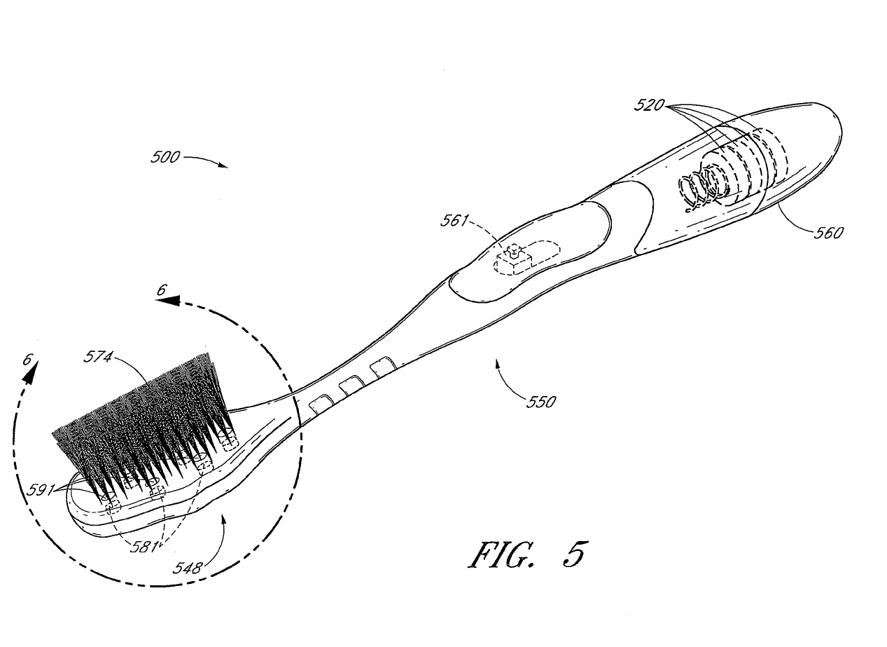

With respect to this embodiment, as shown in FIG. 4A, the head 252 comprises an illumination system within a head body 270. A cover 280 can be positioned over the illumination system. Thus, the cover 280 and the head body 270 cooperate to form the toothbrush head 252 that contains the illumination system. The bristles 74 are fixedly mounted to the cover 280. In some embodiments, including the illustrated embodiment, the cover 280 defines an optical window that allows light to pass therethrough. Thus, the head 252 can have a multi-piece construction.

In other embodiments, the head 252 can have a one-piece construction. The cover 280 and the head body 270 can be monolithically formed. Preferably, the cover 280 and the head body 270 have different optical properties such that more light passes through the cover 280 than the head body 270.

As shown in FIG. 4B, when the switch 250 is moved to the ON position, illumination elements 300 output light. The cover 280 transmits the light such that at least some of the bristles 74 are illuminated. The head 252 can direct the light from the illumination elements 300 towards the bristles 74.

When the user brushes their teeth with the brush 240, the user can activate the illumination elements 300 such that the illumination elements 300 provide a sufficient amount of light to improve viewing of the person's teeth. In low light conditions, the illumination elements 300 ensure that the person can adequately view their teeth during brushing. FIG. 4C illustrates the brush head 252 in low light conditions when the illumination elements are activated. For younger uses, the light also makes the toothbrush more visually interesting and more enjoyable to use.

The cover 280 can be formed of any transparent material. For example, at least a portion of the cover 280 can be formed of polypropylene, polyethylene terephthalate (“PET”), polyethylene, or other semi-transparent or transparent materials. In the illustrated embodiment, a substantial portion of the cover 280 is formed of a transparent material. Although not illustrated, the brush 240 can be a motorized brush that has rotatable bristles 74.

In other embodiments, the toothbrush can include one or more other sensory elements, including blue-colored LEDs. In some embodiments, other sensory elements, either in lieu of or in addition to the illumination elements can be used. For example, the toothbrush can be configured to move (e.g., vibrate), emit a sound and/or the like.

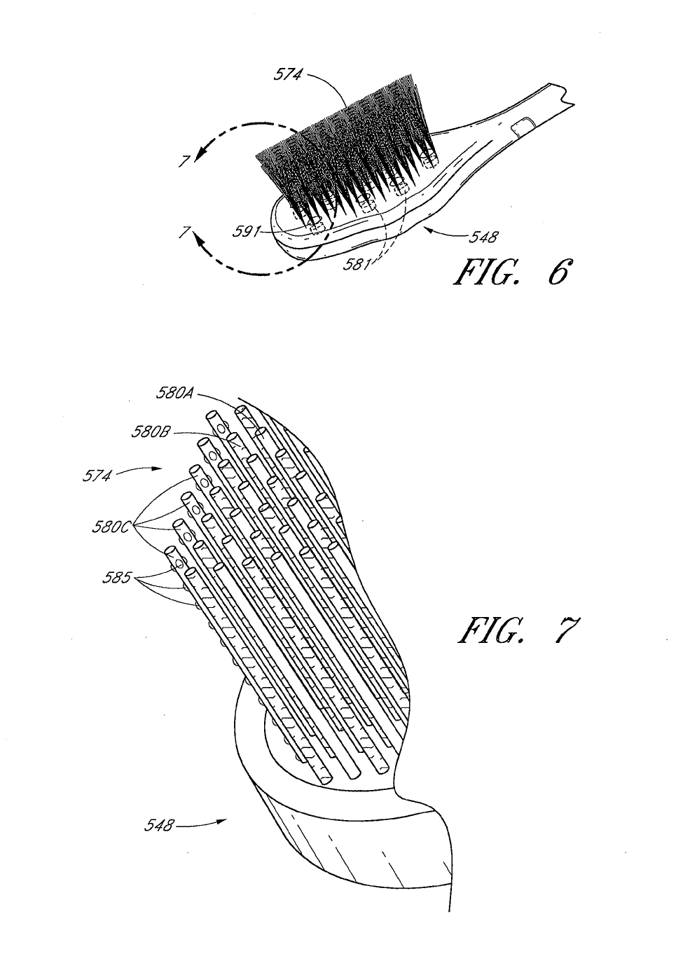

With reference to FIGS. 5-7, another embodiment of a toothbrush 500 having an illumination system is displayed. The toothbrush 500 can have a body 550 and head 548. An enclosure 560 can contain one or more power sources 520. Although a plurality of power sources 520 is displayed, a single source can also be used. The power sources 520 can be dry-cell batteries, including both disposable and rechargeable types. In some embodiments, lithium-ion batteries are used. In other embodiments, alkaline batteries are used. In other embodiments, alternative power sources, such as fuel cells, can be used.

The illumination system can include a switch 561 electrically-connected to the power sources 520. The switch 561 can be similar to the switch described above, operable either by movement in a sliding motion or by depressing the switch 561. The switch 561 can begin a timing mechanism. In some embodiments, the switch 561 is not electrically-connected to a timing mechanism and instead directly controls power between the power sources 520 and lighting elements 581. The lighting elements 581 can be any of the previously described types, including blue-shaded LED elements. The lighting elements 581 can project upwards towards, and in the case of at least partially light-transmitting bristles, through the bristles 574. The lighting elements 581 can be disposed in a transparent or translucent head 548, which can have one or more windows 591 which permit the lighting elements 581 to pass light through the surface of the head 548 with as much or little degradation of the light as desired. The windows 591 can be evenly or unevenly disposed in the head 548.

The bristles 574 can be of any suitable material, including plastics. In some embodiments, nylon strands can be used. In some embodiments, the nylon strands can be produced to have fiber-optic properties and permit the light from the elements 581 to be projected out the end of the bristles 574 through which light is passed.

Further, the bristles 574 can have metallic ion particles disposed in and/or on them, as shown in FIG. 7. In the embodiment illustrated in FIG. 7, various types of metal-tinged bristles 580A-C are displayed. In some embodiments, bristles 580A can have a metallic coating disposed substantially evenly on the bristle, over all or part of the bristle. Other bristles 580B can have particles of metal embedded within the bristle 580B, such as having flecks or flakes of metal disposed in nylon bristles. Other bristles 580C can have metal ion particles 585 affixed to the exterior of the bristle in the regular patterns shown, or uneven, irregular patterns. Some bristles can have more than one type of metallic ion particle, such as particles disposed within the bristle and some particles disposed on the exterior of the bristle. Other combinations can also be produced, including without limitation, a bristle having a coating disposed over a portion of the bristle with additional particles embedded inside the bristle.

In some embodiments, the metal disposed in and/or on the bristles 574 can be silver, ionic silver particles, or silver ion compounds or other metals. Silver can, in ionic or small-particulate form, have anti-microbial properties, including toxicity to bacteria, without causing damage to human tissue. Accordingly, such bristles 580A-C can advantageously reduce the proliferation of bacteria on the toothbrush 500.

In some embodiments where the toothbrush 500 is selected to interact with a dentifrice to produce a whitening effect on teeth, blue LEDs, ultra-violet-emitting LEDs, or a combination of blue, ultra-violet, or other wavelengths of light can be disposed in the toothbrush 500. The dentifrice can be a hydrogen peroxide gel, such as peroxigel, with or without peroxyl, or carbamide peroxide. As light from the LEDs or other lighting elements 581 encounters the dentifrice, it can enhance the effectiveness of the dentifrice's whitening effect, resulting in superior whitening results. Moreover, ions of some metals, including silver, can act as catalyzing agents in the peroxide gel or other dentifrice to increase reaction rate, such as the reaction between the peroxide gel and teeth or impurities on or in the teeth resulting in whitened teeth. Thus, bristles 580 containing at least some silver or other metal disposed on or within the bristle 580 can further enhance the effect of the LEDs to provide enhanced whitening as a result. Additionally, the enhanced whitening can occur more rapidly due to the increased reaction rate. Simultaneously, the anti-microbial/anti-bacterial effect can be present both during and after use due to the presence of the metal particles.

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments disclosed herein. In one non-limiting example, the silver-infused or silver-coated bristles could be combined with rotating bristles. In another non-limiting example, a sliding switch could be used with a plurality of power sources. Similarly, the various features and steps discussed above, as well as other known equivalents for each such feature or step, can be mixed and matched by one of ordinary skill in this art to perform methods in accordance with principles described herein. Additionally, the methods which is described and illustrated herein is not limited to the exact sequence of acts described, nor is it necessarily limited to the practice of all of the acts set forth. Other sequences of events or acts, or less than all of the events, or simultaneous occurrence of the events, may be utilized in practicing the embodiments of the invention.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

What is claimed is:

1. A toothbrush comprising:
a head having a plurality of bristles configured to clean teeth and at least one illumination element that outputs light, the illumination element positioned within the head, and at least one of the plurality of bristles having a plurality of metal particles; and
a body extending from the head, the body defining a handle for gripping by a user, a power source for delivering energy to the at least one illumination element.

2. The toothbrush of claim 1, wherein the metal particles are at least partially composed of silver.

3. The toothbrush of claim 2, wherein the metal particles are at least partially ionized.

4. The toothbrush of claim 1, wherein the plurality of metal particles are disposed within at least one of the plurality of bristles.

5. The toothbrush of claim 4, wherein at least one of the plurality of metal particles extends to a surface of at least one of the plurality of bristles.

6. The toothbrush of claim 1, wherein at least some of the plurality of metal particles are disposed on the surface of at least one of the plurality of bristles.

7. The toothbrush of claim 6, wherein at least some of the plurality of metal particles are disposed at least partially within at least one of the plurality of bristles.

8. The toothbrush of claim 1, wherein further comprising a timing mechanism.

9. The toothbrush of claim 1, further comprising a switch adapted to selectively adjust the illumination element between a first state and a second state.

10. The toothbrush of claim 9, wherein the illumination element is adapted to provide light in the first state, and not provide light in the second state.

11. The toothbrush of claim 10, further comprising a timing mechanism.

12. The toothbrush of claim 11, wherein the timing mechanism is adapted to provide light from the toothbrush during an interval of time after activation of the switch.

13. A method of whitening teeth comprising:
providing a dentifrice;
providing a toothbrush having a plurality of bristles and a light source, at least one of the plurality of bristles having a plurality of metal particles;
applying the dentifrice to at least one tooth;
using the toothbrush to spread the dentifrice across the surface of the at least one tooth.

14. The method of claim 13, wherein the metal particles are at least partially composed of silver.

15. The method of claim 13, wherein the metal particles composed of silver are at least partially ionized.

16. The method of claim 13, further comprising the step of providing light to the dentifrice from within the toothbrush.

17. The method of claim 16, wherein the light has a wavelength selected from a group comprising: ultra-violet light, blue light, and infrared light.

18. The method of claim 13, wherein the toothbrush is used to spread the dentifrice across the surface of the at least one tooth for a definite interval of time.

19. The method of claim 18, wherein the light is provided from the toothbrush is terminated after the interval of time.
